(19) United States
(12) Patent Application Publication
(10) Pub. No.: US 2014/0327405 A1
(43) Pub. Date: Nov. 6, 2014

(54) System and Method for Enhancing the Cost-efficiency of Rechargeable Battery Systems

(71) Applicant: Panacis, Inc., Ottawa (CA)

(72) Inventor: Steve Carkner, Ottawa (CA)

(21) Appl. No.: 14/365,095

(22) PCT Filed: Nov. 15, 2012
(86) PCT No.: PCT/CA2012/050815

§ 371 Date: Jun. 12, 2014

Related U.S. Application Data
(60) Provisional application No. 61/659,722, filed on Jun. 14, 2012.

(51) Int. Cl. B60L 11/18; H02J 7/00

(52) U.S. Cl. CPC B60L 11/1838; H02J 7/007
USPC 320/128

(57) ABSTRACT

A modular battery system includes at least one lithium polymer battery for both mobile and stationary applications. The mobile applications include an electric car and the stationary applications include a house. The battery is exchangeable between the house and the electric car. Both the house and the electric car have a charging apparatus. The battery can be charged when docked with the house by renewable sources and the transported to a second location for docking with another stationary load.

### FIELD OF THE INVENTION

This invention relates to the field of rechargeable battery systems as they relate to both electric vehicle power and renewable home energy systems such as solar and wind power generation.

### BACKGROUND OF THE INVENTION

Battery systems for electric vehicles often include multiple elements that prevent or complicate their ability to be used in a modular format, that is, in a way that the battery can be easily removed and replaced by the driver of the vehicle. The size and weight of these batteries could be broken down into smaller elements, however, systems such as water cooling jackets, electrical connections and variable state of charge and health between modules makes the use of modular batteries in automobiles very cumbersome.

The use of modular batteries in a home off-grid or peak energy reduction system, often coupled with renewable energy sources such as solar or wind energy, is well understood. Banks of lead-acid batteries have been used to create large energy storage banks. The ability to easily swap these batteries however remains a complex task due to the sheer number of batteries, complexity of connections and the need to ensure that the state of charge and health between each battery is properly maintained.

Considering the prior art of the above systems, U.S. patent application Ser. No. 12/025,007 HYBRID VEHICLE WITH MODULAR BATTERY SYSTEM, discloses a modular battery system for an electric vehicle that allows batteries to be removed and added. The goal is rapid replacement of charge into the vehicle with the batteries performing the main drive function.

Similarly, PCT/GB1992/02373 AN ELECTRIC BATTERY POWERED HEAVY VEHICLE, PCT/US2009/039669 BATTERY PACK SYSTEM and U.S. patent application Ser. No. 12/814,486 REFUELABLE BATTERY-POWERED ELECTRIC VEHICLE disclose ways to remove and re-install batteries into vehicles as a way of rapid refuelling. The driving range of the vehicle from the new battery systems is essentially the same as it was from the system being replaced.

U.S. patent application Ser. No. 12/321,241 SWAPPABLE MODULATED BATTERY PACKS SYSTEM FOR ELECTRICALLY DRIVEN VEHICLE provides essentially a business method where the driver chooses the capacity of battery they expect to need for their driving style, then has the option to lease or buy the battery pack. However, the battery is designed to be permanently mounted in the vehicle and provides only a vehicle drive function.

The concept of using electric vehicles to “back feed” into the electricity grid has also been established. In these concepts, the electric vehicle battery would become part of the driver's home-energy system when the vehicle is plugged in. In this way, a home based renewable energy system could recharge the vehicle, or the vehicle could supplement the home energy at night when the sun is not shining.

There are also numerous documented recycling and re-use concepts regarding electric vehicle batteries whereby “worn out” electric vehicle batteries could be connected together to form large battery systems that would still be capable of storing energy from renewable energy sources. Such batteries would be inexpensive since their original purpose in powering electric vehicles would no longer be possible.

While the concepts outlined above generally outline the concepts of modular battery systems that can be used in electric vehicles, and also outline the use of the vehicle battery to power a home or the ability to replace the battery in the vehicle as a way of instant recharging. All of the above systems fail to consider how the electric vehicle battery pack provides a return on investment to the user, how the vehicle range can be extended and how the battery pack, during it's normal functional life, can be made to return value to the driver, even when it is not in use in the vehicle.

### SUMMARY OF THE INVENTION

The system is designed to improve cost efficiency of battery systems by ensuring the owner can recover their investment in the battery in a number of different ways while also improving the value of their electrically powered assets such as their home and vehicle.

A modular battery system that includes a means of operating in parallel with other battery modules such that the connection of two or more units together can be done at any time without reference to the state of charge, state of health or capacity of the battery allows the owner of the battery to utilize the battery in a number of different ways that ensures the battery is used to the greatest extent possible and will therefore return the highest value to the owner.

When used in an electric vehicle, the modular battery will be used only for supplementary power, not as the main vehicle drive. Energy from the modular battery will be fed into the main drive battery of the electric vehicle through a coupling circuit that ensures safety and compatibility of the modular battery and the electric vehicle it is connected to. One or more modular batteries may be used in this way to increase the range of the electric vehicle.

Unlike other modular electric vehicle batteries proposed in the art, the focus of this battery is as a range extender that is added to the vehicle only for long trips. The owner of the battery would remove the batteries when the vehicle is used for normal day-to-day driving. A typical family that only takes monthly trips to visit family and friends outside of the normal driving range of the vehicle would therefore only expect to use the batteries for vehicle purposes perhaps 12 times per year.

The use of the battery only 12 times per year is a critical factor to consider when considering prior art developed around the concept of range extending batteries including the rental model outlined in U.S. application Ser. No. 12/637,821 as outlined in the previous section. Although renting a battery module would provide the owner with the ability to only lease the batteries when required, the time taken to acquire such batteries, install them in the vehicle and return them, together with the cost of leasing such batteries, may make this system unattractive for most families. In addition, the ability to make an emergency long-distance trip would be limited by the availability of leased batteries at that exact time.

Purchasing range extending batteries, when such batteries are expected to be used only 12 times per year is unlikely for most families due to the expected costs involved. If the owner of the batteries could garner additional revenue from such batteries then the purchasing decision would be much easier.

The modular batteries proposed will operate with renewable energy systems in residential and commercial establishments. In this way, energy from renewable sources is stored in the batteries during peak times, and the energy can be sold to the grid when renewable generation drops or at times of the day when the energy rates are highest (peak times). Batteries operated in this way are commonly referred to as “stationary batteries” because they remain in one place for long periods of time.

The concept of solar-shelters for vehicles is also very popular. When parking an electric vehicle in one of these shelters, the solar panels can recharge the vehicle while also providing shade. A significant weakness of these shelters is that home-installation is counter-productive to charging the vehicle for owners that work during the day. In such an installation, the prime time for recharging the vehicle is therefore lost because the vehicle is not present.

A modular battery system can capture solar energy during the day and can be used to recharge the electric vehicle at night, thereby reducing grid demand and saving the owner money on a daily basis.

Combining the uses of the modular battery system as both a vehicle range extender and as a home-based renewable energy storage device ensures that the battery will be put through hundreds of recharge cycles every year. Each recharge cycle is an opportunity for the owner of the battery to recover the value of their initial investment.

An additional benefit of this modular battery concept from a building point of view is the ability to move stored energy from one location to another. In this way, the owner can collect energy at their home, and then transport the energy to their cottage.

An additional benefit of this modular battery concept from a vehicle point of view is the ability to use the battery on multiple vehicles. If the owner has two or more vehicles, the owner can temporarily extend the range of one or more vehicles at any time without the need to purchase or lease a multitude of different battery types.

### DESCRIPTION OF FIGURES

FIG. 1 show the modular battery mounted to an electric vehicle

FIG. 2 shows the modular battery mounted to a home

### DETAILED DESCRIPTION OF PREFERRED EMBODIMENTS OF THE INVENTION

In one embodiment of the invention, the modular battery is composed of a Lithium Polymer battery system coupled to a battery management system that is capable of sharing power, in parallel with other modular batteries on a common power bus. The modular battery system may be used to collect energy from any electrical source of power including renewable sources such as wind and solar as well as sources such as the grid or regenerative braking.

The modular battery system may be used to deliver energy to any electrical load including the power grid, the home, or to an automobile.

The modular battery system may be used at a residence, commercial building or recreational building and may be moved between these buildings. The modular battery is also designed to allow it to function as an alternate energy source when removeably mounted in an electric vehicle.

The modular battery system will be used with a power converter that is mounted, either permanently or removeably, in each application. For example, where a 400 volt electric vehicle is used, a power converter to produce 400 volts from the battery will be installed. For electric vehicles that require 300 volts, a different power converter will be installed, or the power converter will be adjusted to the new voltage. Where the power demands of the application match the power delivery of the batteries, it is possible that no converter will be required.

In the case of an electric vehicle, the batteries would be expected to mount in the trunk, on the roof, on a trailer hitch, or on a towable trailer itself.

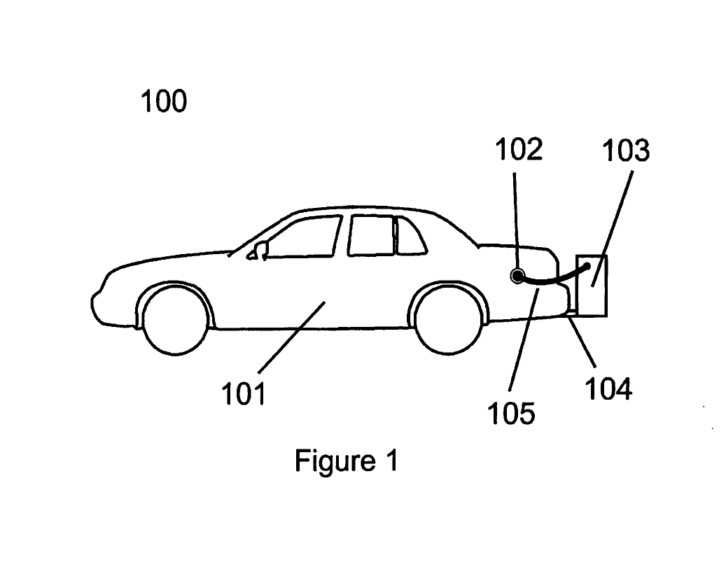

FIG. 1 shows a typical range extended electric vehicle application (100). The electric vehicle (101) includes a recharging port (102). The modular battery holder (103) may include one or more modular batteries and a power converter, if required. The modular battery holder (103) mounts to the vehicle's trailer hitch (104) and transfers power to and from the vehicle using a connection cable (105). As previously described, the batteries may mount in a number of other ways and the vehicle connection may be via the existing recharging port on the vehicle, or through an auxiliary port that is included with, or retrofitted into an existing electric vehicle.

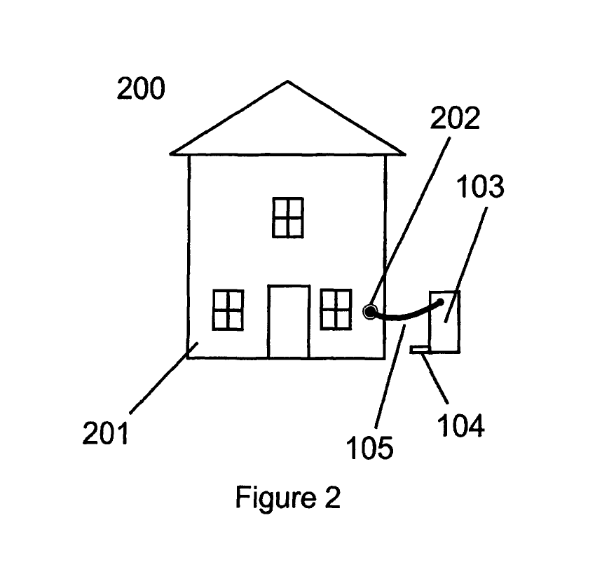

FIG. 2 shows a typical stationary application (200), in this case a home (201) that may include wind, solar and grid power connections. This may also represent a cottage or commercial building which may or may not be tied to the standard electrical distribution grid. The home (201) includes a power outlet (202) designed for an energy storage device, or this may be simply a connection to another energy storage stationary battery, power converter or electrical bus within the home. The modular battery holder (103) may include one or more modular batteries and a power converter, if required. The modular battery holder (103) may mount inside or outside the home using the same trailer hitch (104) connection as used on the electric vehicle shown in FIG. 1, or it may simply sit on the ground or on the floor, for example in a garage. The modular battery holder connects to the home through the connection cable (105).

Multiple modular battery holders (103) may be used to house one or more batteries and power converters. There is no expectation that the amount of energy stored would need to be limited in any way, many modular batteries can be connected together to provide the amount of storage thought necessary by the owner.

Consider the value proposition of the batteries. Assuming that an electric vehicle normally contains a battery of E watt-hours, then doubling the range of the vehicle would require the additional E watt-hours of energy storage (discounting the effect on vehicle efficiency due to the extra weight of the batteries). If the user places a value of P dollars-per-watt-hour on the energy stored and makes N trips per year using the extra battery power that was added, then a single use range-extending battery would be valued at:

Yearly value of range extender=E*P*N

For example, a 40 kWhr battery with a value of $0.30/kWhr and making 12 trips per year would value the battery at $144 per year. Of course, the actual perceived value to the family to be able to take their vehicle on longer trips may far exceed the actual dollar value placed on such extra mileage.

Assuming the battery costs X dollars-per-watt-hour, then:

Cost of range extender=X*E

A typical price for an electric vehicle battery is $1000/kWhr; therefore the 40 kWhr battery would have an expected initial price of $40,000.

Clearly, the battery when used only as a range extender will never pay for itself on a straight economic model, even considering the perceived extra value of extending the range of an electric vehicle, a price of $40,000 is likely too high for most families to contemplate for the occasional trip to visit family and friends.

When considering the value of the battery system to store excess renewable energy is R, under Ontario, Canada's 2011 Microfit program, renewable energy was valued at $0.80/kWhr. Assuming that the days when long trips were made is deducted from the number of days in a year, then the battery value per year, if used to store excess renewable energy on a daily basis is:

Yearly value of Renewable storage battery:E*R*(365−12)

Therefore, the 40 kWhr battery at a rate of $0.80/day will generate as much as $11,296 per year. This would allow the battery to pay for itself on a straight economic recovery scale in around four years. The added benefit of using the battery to extend the range of a vehicle increases the appeal of the battery system to average families and further decreases the perceived time to achieve a positive return on investment.

In one embodiment of the invention there is provided a system for providing electrical energy to an at least one load comprising at least one portable modular battery for storing electrical energy at a first voltage; a housing for enclosing the at least one portable modular battery; wherein the at least one load has a second voltage; and, at least one voltage conversion device disposed between the at least one portable modular battery and the at least one load for converting the first voltage to the second voltage. The housing enclosing the at least one portable modular battery is transportable between the first load and the second load.

In another embodiment of the invention there is provided a system for providing electrical energy to an at least one load comprising a plurality of portable modular batteries for storing the electrical energy at a first voltage; a housing for enclosing the plurality of portable modular batteries, wherein the housing is electrically connectible and mountable to the at least one load; a common bus for connecting the plurality of portable modular batteries in a desired configuration; a battery management device for proper load sharing between the plurality of portable modular batteries and for proper recharging of the plurality of portable modular batteries. The at least one load has a second voltage. There is also an at least one voltage conversion device disposed between the common bus and the at least one load for converting the first voltage to the second voltage. The at least one voltage conversion device can be a power converter for matching a battery output to a load demand. The power converter comprises an automatic voltage adjuster to adjust the first voltage to the second voltage. The system further includes a battery charging circuit comprising a renewable source of power such as solar power and wind power. The housing includes exterior battery discharge terminals having a connection to the common bus. The battery management device, the common bus and the voltage conversion device are enclosed within the housing. The housing is environmentally sealed. The at least one load comprises a stationary load and a mobile load and the housing is transportable between the stationary load and the mobile load. The stationary load can be one of a building and a power grid having a first receptacle for connection to the exterior battery discharge terminals. The mobile load can be one of an electric vehicle and a hybrid electric vehicle having a second receptacle for connection to the exterior battery discharge terminals. In one embodiment of the invention the plurality of portable modular batteries comprise lithium polymer batteries in a parallel configuration. The housing includes a mounting device for secure mounting of the housing to a chassis of the electric vehicle and hybrid vehicle. The second receptacle on the electric or hybrid vehicle comprises a recharging port for recharging a vehicle battery system.

In another embodiment of the invention there is provided a cost-effective system for common use of a plurality of portable modular batteries for storing renewable energy at a first voltage between a stationary residential load at a second voltage and a mobile electric vehicle load at a third voltage. The system comprises a common bus for connecting the plurality of portable modular batteries in a parallel configuration; a transportable housing for enclosing the common bus and the plurality of portable modular batteries. The transportable housing is environmentally sealed and electrically connectible and mountable to the stationary residential load and the mobile electric vehicle load. The system further comprises a battery management device for proper load sharing between the plurality of portable modular batteries and for proper recharging of the plurality of portable modular batteries using a recharging circuit comprising a source of renewable energy. There is further included an automatic voltage conversion device converting the first voltage to one of the second voltage and the third voltage. On the exterior of the housing is a set of battery discharge terminals and connected to the common bus. The set of battery terminals are receivable by a first receptacle connected to the stationary residential load and a second receptacle connected to mobile electric vehicle load so that when the mobile electric vehicle load is not connected the transportable housing it can be disconnected from the second receptacle and easily transported to and connected to the first receptacle for providing power to the stationary residential load. The plurality of portable modular batteries comprises lithium polymer batteries.

The invention also teaches a cost-effective method for common use of a plurality of portable modular batteries by transporting renewable energy between a stationary residential load having a first electrical connection receptacle and a mobile electric vehicle load having a second electrical connection receptacle. The method comprises the following steps:
a. connecting the plurality of portable modular batteries to a common bus in a parallel configuration;
b. enclosing the plurality of portable modular batteries and the common bus in a transportable and environmentally sealed housing;
c. connecting a battery management device to the plurality of portable modular batteries for proper load sharing and recharging;
d. installing a recharging circuit comprising one of a power grid and a source of renewable energy connectable to the common bus;
e. connecting an automatic power conversion device to the common bus for matching a battery output to a load demand;
f. installing a set of battery discharge terminals on the exterior of the transportable housing having a connection to the common bus, wherein the set of battery terminals are received by the first receptacle and the second receptacle;
g. satisfying the mobile electrical vehicle load demand by:
   i. disconnecting the transportable and environmentally sealed housing from the recharging circuit;
   ii. transporting the transportable and environmentally sealed housing to the mobile electrical vehicle load; and,
   iii. connecting the set of discharge terminals to the second receptacle; and,
h. satisfying the stationary residential load by:
   i. disconnecting the set of discharge terminals from the second receptacle;
   ii. transporting the transportable and environmentally sealed housing from the mobile electrical vehicle load to the stationary residential load; and,
   iii. connecting the set of discharge terminals to the first receptacle.

While the invention has been described in terms of what is presently considered to be the most practical and preferred embodiments, it is to be understood that the invention needs not be limited to the disclosed embodiment. It is intended to cover various modifications and similar arrangements included within the spirit and scope of the appended claims which are to be accorded with the broadest interpretation so as to encompass all such modifications and similar structures.

What is claimed is:

1. A system for transporting electrical energy from a first load to a second load, said system comprising:
a. a plurality of portable modular batteries for storing said electrical energy;
b. a battery management device connected to said plurality of portable modular batteries for load sharing and recharging;
c. wherein said first load has a first power characteristic;
d. wherein said second load has a second power characteristic; and,
e. at least one power conversion circuit disposed between said plurality of portable modular batteries and the first and second loads for automatically adapting the stored electrical energy to said first and said second power characteristics.

2. The system of claim 1 further including a common bus for connecting the plurality of portable modular batteries in a desired configuration.

3. The system of claim 2 further comprising a housing for enclosing said plurality of portable modular batteries, wherein said housing includes an electrical connection connectible and mountable to the first load and the second load.

4. The system of claim 3 wherein said at least one power conversion circuit matches a battery output to a load demand.

5. The system of claim 4 wherein the at least one power conversion circuit comprises an automatic voltage adjuster.

6. The system of claim 5 further including a battery charging circuit comprising one of an electrical grid and a renewable source of power.

7. The system of claim 6 wherein the housing includes exterior battery discharge terminals having a connection to said common bus.

8. The system of claim 7 wherein said battery management device, the common bus and the power conversion circuit are enclosed within the housing and wherein the housing is environmentally sealed.

9. The system of claim 8 wherein the first load comprises a stationary load and the second load comprises a mobile load.

10. The system of claim 9 wherein the housing is transportable between said stationary load and said mobile load.

11. The system of claim 10 wherein the stationary load is one of a building and a power grid having a first receptacle for connection to said exterior battery discharge terminals and wherein the mobile load is one of an electric vehicle and a hybrid electric vehicle having a second receptacle for connection to the exterior battery discharge terminals.

12. The system of claim 11 wherein the plurality of portable modular batteries comprise lithium polymer batteries.

13. The system of claim 12 wherein said desired configuration is a parallel configuration.

14. The system of claim 13 wherein the housing includes a mounting device for secure mounting of the housing to a chassis of the electric vehicle and the hybrid vehicle.

15. The system of claim 14 wherein said second receptacle comprises a recharging port for recharging a battery system of the electric vehicle and the hybrid vehicle.

16. A cost-effective system for common use of a plurality of portable modular batteries for transporting renewable energy between a stationary residential load and a mobile electric vehicle load, said system comprising:
a. a common bus for connecting said plurality of portable modular batteries in a parallel configuration;
b. a transportable housing for enclosing said common bus and the plurality of portable modular batteries, wherein said transportable housing is environmentally sealed and electrically connectible and mountable to said stationary residential load and said mobile electric vehicle load;
c. a battery management device for proper load sharing and recharging of the plurality of portable modular batteries;
d. a recharging circuit comprising a source of renewable energy; and,
e. an automatic power conversion device matching a battery output to a load demand.

17. The system of claim 16 wherein a set of battery discharge terminals is disposed on the exterior of the transportable housing and having a connection to said common bus, wherein said set of battery terminals are received by a first receptacle connected to the stationary residential load and a second receptacle connected to mobile electric vehicle load.

18. The system of claim 17 wherein when the mobile electric vehicle load is not connected to the transportable housing, the transportable housing can be disconnected from the second receptacle and easily transported to and connected to said first receptacle for providing power to the stationary residential load.

19. The system of claim 18 wherein the plurality of portable modular batteries are lithium polymer batteries.

20. A cost-effective method for common use of a plurality of portable modular batteries by transporting renewable energy between a stationary residential load having a first electrical connection receptacle and a mobile electric vehicle load having a second electrical connection receptacle, said method comprising the following steps:
a. connecting said plurality of portable modular batteries to a common bus in a parallel configuration;
b. enclosing the plurality of portable modular batteries and said common bus in a transportable and environmentally sealed housing;
c. connecting a battery management device to the plurality of portable modular batteries for proper load sharing and recharging;
d. installing a recharging circuit comprising one of a power grid and a source of renewable energy connectable to the common bus;
e. connecting an automatic power conversion device to the common bus for matching a battery output to a load demand;
f. installing a set of battery discharge terminals on the exterior of the transportable housing having a connection to the common bus, wherein said set of battery terminals are received by said first receptacle and said second receptacle;
g. satisfying the mobile electrical vehicle load demand by:
i. disconnecting said transportable and environmentally sealed housing from said recharging circuit;
ii. transporting the transportable and environmentally sealed housing to the mobile electrical vehicle load; and,
iii. connecting the set of discharge terminals to the second receptacle; and,
h. satisfying the stationary residential load by:
i. disconnecting the set of discharge terminals from the second receptacle;
ii. transporting the transportable and environmentally sealed housing from the mobile electrical vehicle load to the stationary residential load; and,
iii. connecting the set of discharge terminals to said first receptacle.
